(19) United States
(12) Patent Application Publication
(10) Pub. No.: US 2026/0027812 A1
(43) Pub. Date: Jan. 29, 2026

(54) MULTILAYERED THERMOPLASTIC BAGS WITH ENHANCED DART IMPACT RESISTANCE

(71) Applicant: The Glad Products Company, Oakland, CA (US)

(72) Inventors: Michael G. BORCHARDT, Naperville, IL (US); Anthony A. CISEK, Willowbrook, IL (US)

(21) Appl. No.: 18/786,306

(22) Filed: Jul. 26, 2024

(51) Int. Cl. B32B 27/08; B32B 3/28; B32B 7/14; B65D 33/28; B65F 1/00

(52) U.S. Cl. CPC B32B 27/08; B32B 3/28; B32B 7/14; B65D 33/28; B65F 1/002; B32B 2307/581; B32B 2439/06

(57) ABSTRACT

The present disclosure relates to multilayered thermoplastic bags with deformations such as raised rib-like elements and regions of delamination between layers. In particular, in one or more embodiments, the disclosed thermoplastic bags include a first sidewall and a second sidewall joined together along a first side edge, a second side edge, and a bottom edge, while having an opening opposite the bottom edge. Furthermore, in some embodiments, the disclosed thermoplastic bags have regions of deformations with lamination between layers and other regions of deformations with delaminated layers. The delaminated layers can serve to increase dart impact resistance of the thermoplastic bags.

### BACKGROUND

Among their many applications, thermoplastic bags are used as liners in trash or refuse receptacles. Such liners can be found at many locations from small household kitchen garbage cans to larger, multi-gallon drums located in public places and restaurants. Bags that are intended to be used as liners for such refuse containers are typically made from low-cost, pliable thermoplastic material. When the receptacle is full, the thermoplastic liner holding the trash may be removed for disposal and replaced with a new liner. A common problem with thermoplastic bags is leakage or spillage of liquid and/or solid refuse through a puncture or tear in the bag. For instance, a trash bag can sustain tears, rips, punctures, or other failures due to heavy weight of the trash and/or sharp objects in the trash, among other causes. Consequently, the liquid and/or solid trash can flow through the tears, rips, or punctures and out of the bag, thereby causing leaks or spills into the trash receptacle and/or onto floors or the ground when transporting the trash bag to a dumpster. Thus, there is a need for thermoplastic bags with capabilities to mitigate the problem of tears, rips, and punctures in trash bags.

### BRIEF SUMMARY

Embodiments of the present disclosure provide benefits and/or solve one or more of the foregoing or other problems in the art with thermoplastic bags that have enhanced dart impact resistance over conventional thermoplastic bags. For example, in some embodiments, the disclosed thermoplastic bags include multiple films of thermoplastic material that have initially been lightly laminated together in a deformation operation, and subsequently delaminated in a delamination operation. More particularly, in some embodiments, the thermoplastic bags include a plurality of deformations, with bonds joining the multiple films at locations aligned with the plurality of deformations. In some embodiments, some (or all) of the bonds are broken to delaminate the multiple films. In some cases, by delaminating the multiple films, the thermoplastic bags acquire increased dart impact resistance compared to bags that remain laminated. Specifically, delaminating the films helps ensure that any stress concentrations or weak points formed in the individual films during formation of the deformations are misaligned, thereby increasing the strength of the thermoplastic bags by helping prevent holes and tears. Moreover, in some embodiments, the disclosed thermoplastic bags include delaminated regions near likely points of high stress, such as a bottom edge, a side edge, and/or a hem of the bag. For instance, in some implementations, the disclosed thermoplastic bags have multiple films that partially remain laminated (after lamination in a deformation operation) at a first region, while being partially delaminated at a second region.

For example, in one or more implementations, a thermoplastic bag includes an outer first thermoplastic bag comprising first and second opposing sidewalls joined together along a first side edge, an opposite second side edge, an open first top edge, and a closed first bottom edge. The thermoplastic bag also includes an inner second thermoplastic bag positioned within the outer first thermoplastic bag, the inner second thermoplastic bag comprising third and fourth opposing sidewalls joined together along a third side edge, an opposite fourth side edge, an open second top edge, and a closed second bottom edge. The thermoplastic bag also includes a region in the first sidewall and the third sidewall comprising a plurality of deformations and a plurality of bonds joining the first sidewall to the third sidewall, the plurality of bonds aligned with the plurality of deformations. The thermoplastic bag also includes a subregion within the region, wherein bonds of the plurality of bonds between the first sidewall and the third sidewall in the subregion are broken. The subregion has a greater puncture resistance than portions of the region comprising intact bonds.

In another implementation, a thermoplastic bag includes a first multi-film sidewall comprising a first thermoplastic film layer and a second thermoplastic film layer and a second multi-film sidewall comprising a third thermoplastic film layer and a fourth thermoplastic film layer. The thermoplastic bag also includes a first region in the first multi-film sidewall. The first region comprises a first plurality of deformations in both the first and second thermoplastic film layers and a first plurality of bonds joining the first thermoplastic film layer to the second thermoplastic film layer. The plurality of bonds are aligned with the plurality of deformations. The first region comprising a first puncture resistance. The thermoplastic bag includes a second region in the first multi-film sidewall. The second region comprises a second plurality of deformations in both the first and second thermoplastic film layers. The second region is devoid of bonds joining the first thermoplastic film layer to the second thermoplastic film layer. Also, the second region has a second puncture resistance that is greater than the first puncture resistance of the first region.

The following description sets forth additional features and advantages of one or more embodiments of the disclosed thermoplastic bags. In some cases, such features and advantages are evident to a skilled artisan having the benefit of this disclosure, or may be learned by the practice of the disclosed embodiments.

### BRIEF DESCRIPTION OF THE DRAWINGS

The detailed description provides one or more embodiments with additional specificity and detail through the use of the accompanying drawings, as briefly described below.

FIGS. 1A-1C illustrate partial side cross-sectional views of films having varying numbers of layers that can be included in a thermoplastic bag in accordance with one or more embodiments.

FIG. 2 illustrates a perspective view of a pair of SELF'ing rollers utilized to form patterns of raised rib-like elements in films in accordance with one or more embodiments.

FIG. 3 illustrates a perspective view of a SELF'ed film having a pattern of raised rib-like elements in accordance with one or more embodiments.

FIG. 4 illustrates a perspective view of a multi-film SELF'ed laminate having a pattern of raised rib-like elements in accordance with one or more embodiments.

FIGS. 5A-5B illustrate perspective views of thermoplastic bags in accordance with one or more embodiments.

FIG. 5C illustrates a cross-sectional view of the thermoplastic bag of FIG. 5B in accordance with one or more embodiments.

FIGS. 6A-6B illustrate front views of thermoplastic bags in accordance with one or more embodiments.

FIG. 7 illustrates a schematic diagram of a process of manufacturing a thermoplastic bag in accordance with one or more embodiments.

### DETAILED DESCRIPTION

This disclosure describes one or more embodiments of thermoplastic bags that have enhanced dart impact resistance over conventional bags. For example, in some embodiments, the disclosed thermoplastic bags include multiple films of thermoplastic material that have initially been lightly laminated together in a deformation operation, and subsequently delaminated in a delamination operation. More particularly, in some embodiments, the thermoplastic bags include a plurality of deformations in the multiple films, with bonds joining the multiple films at locations aligned with the plurality of deformations. In some embodiments, some (or all) of the bonds are broken to delaminate the multiple films. In some cases, by delaminating the multiple films, the thermoplastic bags acquire increased dart impact resistance over bags that remain laminated.

To illustrate, in some implementations, a thermoplastic bag having two layer film structures that are lightly laminated together has increased dart impact resistance and increased tear resistance compared to a similar bag in which the films remain fully laminated. In some cases, when a multi-film thermoplastic bag is tested for dart impact resistance (e.g., by dropping a dart on the film), a dart will tend to center itself on a motif of deformations before puncturing the film. This centering effect can lead the dart to finding a weak point in the film. When the multiple films are lightly laminated by a deformation process, the weak points in the film are aligned. Thus, an object puncturing the thermoplastic bag, due to the centering effect, will pass through the corresponding weak points in each film of the laminate. By contrast, if the multi-film thermoplastic bag is delaminated (e.g., after first being laminated together), an object that punctures a weak point in a first film (for example due to a centering effect) will not likely be aligned with a corresponding weak point in the next delaminated layer due to the ability of the films to move relative to each other. Thus, a dart will not find a corresponding weak point in each film of the laminate, and thus, an ability of the laminate to resist dart impacts is enhanced by the delamination of the films.

One or more implementations provide for forming bonds between adjacent layers of a multi-film thermoplastic bag that are relatively light such that forces acting on the multi-film bag are first absorbed by breaking the bonds rather than, or prior to, tearing or otherwise causing the failure of the films of the multi-film bag. Such implementations can provide an overall thinner film employing a reduced amount of raw material that nonetheless has maintained or increased strength parameters. Alternatively, such implementations can use a given amount of raw material and provide a film with increased strength parameters.

In particular, the non-continuous bonds or bond regions of adjacent layers of multi-film thermoplastic bags in accordance with one or more implementations can act to first absorb forces via breaking of the bonds prior to allowing that same force to cause failure of the individual films of the multi-film thermoplastic bags. Such action can provide increased strength to the multi-film thermoplastic bags. In one or more implementations, the non-continuous bonds or bond regions include a bond strength that is advantageously less than a weakest tear resistance of each of the individual films so as to cause the bonds to fail prior to failing of the films. Indeed, one or more implementations include bonds that the release just prior to any localized tearing of the films of the multi-film thermoplastic bags.

Thus, in one or more implementations, the non-continuous bonds or bond regions of a multi-film thermoplastic bag can fail before either of the individual films undergo molecular-level deformation. For example, an applied strain can pull the non-continuous bonds or bond regions apart prior to any molecular-level deformation (stretching, tearing, puncturing, etc.) of the individual film layers. In other words, the light bonds or bond regions can provide less resistive force to an applied strain than molecular-level deformation of any of the films of the multi-film thermoplastic bags. The inventors have surprisingly found that such a configuration of light bonding can provide increased strength properties to the multi-film thermoplastic bags as compared to a film or bag with a monolayer equal thickness or a multi-film thermoplastic bags in which the plurality of layers are tightly bonded together (e.g., coextruded).

As mentioned above, in one or more implementations, the multi-film thermoplastic bags comprise one or more areas with delaminated bonds. Such areas can comprise increased dart impact resistance compared to areas having intact bonds. One or more implementations of the present invention provide for tailoring different regions of multi-film thermoplastic bags with different strength parameters/characteristics. For example, one or more implementations include tailoring to deliver a bag with zones or sections with tailored strength, tear resistance, and puncture resistance.

To illustrate, in one or more embodiments, the disclosed thermoplastic bags include delaminated regions near likely points of high stress, such as a bottom edge, a side edge, and/or a hem of the bag. For instance, in some implementations, the disclosed thermoplastic bags have multiple films that remain non-continuously laminated (after lamination in a deformation operation) in a first region, while being delaminated in a second region. The regions with delaminated bonds can have increased puncture resistance compared to the regions with intact bonds.

Relatively weak bonding of the two or more films of the multi-layer film or bag can be accomplished through one or more suitable techniques. For example, bonding may be achieved by pressure (for example MD ring rolling, TD ring rolling, stainable network lamination, or embossing), or with a combination of heat and pressure. Alternately, the film layers can be lightly laminated by ultrasonic bonding. Alternately, the films can be laminated by adhesives. Treatment with a Corona discharge can enhance any of the above methods. Prior to lamination, the separate layers can be flat film or can be subject to separate processes, such as stretching, slitting, coating and printing, and corona treatment.

One or more implementations include thermoplastic films with deformations including raised rib-like elements in strainable networks created by a complex structural elastic-like film (e.g., SELF or SELF'ing) process. The strainable network can comprise a plurality of raised rib-like elements extending in a direction perpendicular to a main surface of the thermoplastic film (i.e., a Z-direction). The raised rib-like elements are surrounded by a plurality of web areas. The raised rib-like elements and web areas can comprise a strainable network that provides the thermoplastic film with an elastic-like behavior as well as a tactile feel. U.S. Pat. Nos. 5,518,801 and 5,650,214 each disclose processes for forming strainable networks using SELF'ing processes. The contents of each of the aforementioned patents are incorporated by reference herein in their entirety.

As an initial matter, the thermoplastic material of the films of one or more implementations of the present disclosure may include thermoplastic polyolefins, including polyethylene and copolymers thereof and polypropylene and copolymers thereof. The olefin-based polymers may include ethylene or propylene-based polymers such as polyethylene, polypropylene, and copolymers such as ethylene vinyl acetate (EVA), ethylene methyl acrylate (EMA) and ethylene acrylic acid (EAA), or blends of such polyolefins.

Other examples of polymers suitable for use as films in accordance with the present disclosure may include elastomeric polymers. Suitable elastomeric polymers may also be biodegradable or environmentally degradable. Suitable elastomeric polymers for the film include poly(ethylene-butene), poly(ethylene-hexene), poly(ethylene-octene), poly(ethylene-propylene), poly(styrene-butadiene-styrene), poly(styrene-isoprene-styrene), poly(styrene-ethylene-butylene-styrene), poly(ester-ether), poly(ether-amide), poly(ethylene-vinylacetate), poly(ethylene-methylacrylate), poly(ethylene-acrylic acid), oriented poly(ethylene-terephthalate), poly(ethylene-butylacrylate), polyurethane, poly(ethylene-propylene-diene), ethylene-propylene rubber, nylon, etc.

Some of the examples and description herein refer to films formed from linear low-density polyethylene. The term “linear low-density polyethylene” (LLDPE) as used herein is defined to mean a copolymer of ethylene and a minor amount of an olefin containing 4 to 10 carbon atoms, having a density of from about 0.910 to about 0.930, and a melt index (MI) of from about 0.5 to about 10. For example, some examples herein use an octene comonomer, solution phase LLDPE (MI=1.1; ρ=0.920). Additionally, other examples use a gas phase LLDPE, which is a hexene gas phase LLDPE formulated with slip/AB (MI=1.0; ρ=0.920). Still further examples use a gas phase LLDPE, which is a hexene gas phase LLDPE formulated with slip/AB (MI=1.0; ρ=0.926). One will appreciate that the present disclosure is not limited to LLDPE and can include “high density polyethylene” (HDPE), “low density polyethylene” (LDPE), and “very low density polyethylene” (VLDPE). Indeed, films made from any of the previously mentioned thermoplastic materials or combinations thereof can be suitable for use with the present disclosure.

Some implementations of the present disclosure may include any flexible or pliable thermoplastic material that may be formed or drawn into a web or film. Furthermore, the thermoplastic materials may include a single layer or multiple layers. The thermoplastic material may be opaque, transparent, translucent, or tinted. Furthermore, the thermoplastic material may be gas permeable or impermeable.

As used herein, the term “flexible” refers to materials that are capable of being flexed or bent, especially repeatedly, such that they are pliant and yieldable in response to externally applied forces. Accordingly, “flexible” is substantially opposite in meaning to the terms inflexible, rigid, or unyielding. Materials and bags that are flexible, therefore, may be altered in shape and structure to accommodate external forces and to conform to the shape of objects brought into contact with them without losing their integrity. In accordance with further prior art materials, web materials are provided which exhibit an “elastic-like” behavior in the direction of applied strain without the use of added traditional elastic materials. As used herein, the term “elastic-like” describes the behavior of web materials which when subjected to an applied strain, the web materials extend in the direction of applied strain, and when the applied strain is released the web materials return, to a degree, to their pre-strained condition.

As used herein, the term “substantially,” in reference to a given parameter, property, or condition, means to a degree that one of ordinary skill in the art would understand that the given parameter, property, or condition is met within a degree of variance, such as within acceptable manufacturing tolerances. By way of example, depending on the particular parameter, property, or condition that is substantially met, the parameter, property, or condition may be at least 70.0% met, at least 80.0%, at least 90% met, at least 95.0% met, at least 99.0% met, at least 99.9% met, or even 100% met.

Additional additives that may be included in one or more implementations include slip agents, anti-block agents, voiding agents, or tackifiers. Additionally, one or more implementations of the present disclosure include films that are devoid of voiding agents. Some examples of inorganic voiding agents, which may further provide odor control, include the following but are not limited to calcium carbonate, magnesium carbonate, barium carbonate, calcium sulfate, magnesium sulfate, barium sulfate, calcium oxide, magnesium oxide, titanium oxide, zinc oxide, aluminum hydroxide, magnesium hydroxide, talc, clay, silica, alumina, mica, glass powder, starch, charcoal, zeolites, any combination thereof, etc. Organic voiding agents, polymers that are immiscible in the major polymer matrix, can also be used. For instance, polystyrene can be used as a voiding agent in polyethylene and polypropylene films.

One of ordinary skill in the art will appreciate in view of the present disclosure that manufacturers may form the films or webs to be used with the present disclosure using a wide variety of techniques. For example, a manufacturer can form precursor mix of the thermoplastic material and one or more additives. The manufacturer can then form the film(s) from the precursor mix using conventional flat or cast extrusion or co-extrusion to produce monolayer, bilayer, or multilayer films. Alternatively, a manufacturer can form the films using suitable processes, such as, a blown film process to produce monolayer, bilayer, or multilayer films. If desired for a given end use, the manufacturer can orient the films by trapped bubble, tenterframe, or other suitable process. Additionally, the manufacturer can optionally anneal the films thereafter.

An optional part of the film-making process is a procedure known as “orientation.” The orientation of a polymer is a reference to its molecular organization, i.e., the orientation of molecules relative to each other. Similarly, the process of orientation is the process by which directionality (orientation) is imposed upon the polymeric arrangements in the film. The process of orientation is employed to impart desirable properties to films, including making cast films tougher (higher tensile properties). Depending on whether the film is made by casting as a flat film or by blowing as a tubular film, the orientation process can require different procedures. This is related to the different physical characteristics possessed by films made by conventional film-making processes (e.g., casting and blowing). Generally, blown films tend to have greater stiffness and toughness. By contrast, cast films usually have the advantages of greater film clarity and uniformity of thickness and flatness, generally permitting use of a wider range of polymers and producing a higher quality film.

When a film has been stretched in a single direction (mono-axial orientation), the resulting film can exhibit strength and stiffness along the direction of stretch, but can be weak in the other direction, i.e., across the stretch, often splitting when flexed or pulled. To overcome this limitation, two-way or biaxial orientation can be employed to more evenly distribute the strength qualities of the film in two directions. Most biaxial orientation processes use apparatus that stretches the film sequentially, first in one direction and then in the other.

In one or more implementations, the films of the present disclosure are blown film, or cast film. Both a blown film and a cast film can be formed by extrusion. The extruder used can be a conventional one using a die, which will provide the desired gauge. Some useful extruders are described in U.S. Pat. Nos. 4,814,135; 4,857,600; 5,076,988; 5,153,382; each of which are incorporated herein by reference in their entirety. Examples of various extruders, which can be used in producing the films to be used with the present disclosure, can be a single screw type modified with a blown film die, an air ring, and continuous take off equipment.

In one or more implementations, a manufacturer can use multiple extruders to supply different melt streams, which a feed block can order into different channels of a multi-channel die. The multiple extruders can allow a manufacturer to form a film with layers having different compositions. Such multi-film bag may later be provided with a complex stretch pattern to provide the benefits of the present disclosure.

In a blown film process, the die can be an upright cylinder with a circular opening. Rollers can pull molten thermoplastic material upward away from the die. An air-ring can cool the film as the film travels upwards. An air outlet can force compressed air into the center of the extruded circular profile, creating a bubble. The air can expand the extruded circular cross section by a multiple of the die diameter. This ratio is called the “blow-up ratio.” When using a blown film process, the manufacturer can collapse the film to double the plies of the film. Alternatively, the manufacturer can cut and fold the film, or cut and leave the film unfolded.

In any event, in one or more implementations, the extrusion process can orient the polymer chains of the blown film. The “orientation” of a polymer is a reference to its molecular organization, i.e., the orientation of molecules or polymer chains relative to each other. In particular, the extrusion process can cause the polymer chains of the blown film to be predominantly oriented in the machine direction. The orientation of the polymer chains can result in an increased strength in the direction of the orientation. As used herein predominately oriented in a particular direction means that the polymer chains are more oriented in the particular direction than another direction. One will appreciate, however, that a film that is predominately oriented in a particular direction can still include polymer chains oriented in directions other than the particular direction. Thus, in one or more implementations the initial or starting films (films before being stretched or bonded or laminated in accordance with the principles described herein) can comprise a blown film that is predominately oriented in the machine direction.

The process of blowing up the tubular stock or bubble can further orient the polymer chains of the blown film. In particular, the blow-up process can cause the polymer chains of the blown film to be bi-axially oriented. Despite being bi-axially oriented, in one or more implementations the polymer chains of the blown film are predominantly oriented in the machine direction (i.e., oriented more in the machine direction than the transverse direction).

The films of one or more implementations of the present disclosure can have a starting gauge between about 0.1 mils to about 20 mils, suitably from about 0.2 mils to about 4 mils, suitably in the range of about 0.2 mils to about 2 mils, suitably from about 0.6 mils to about 1.25 mils, suitably from about 0.9 mils to about 1.1 mils, suitably from about 0.3 mils to about 0.7 mils, and suitably from about 0.3 mils and about 0.6 mils. Additionally, the starting gauge of films of one or more implementations of the present disclosure may not be uniform. Thus, the starting gauge of films of one or more implementations of the present disclosure may vary along the length and/or width of the film.

As described above, a multi-film thermoplastic bag includes a plurality of thermoplastic films. Each individual film may itself include a single layer or multiple layers. In other words, the individual films of the multi-film bag may each themselves comprise a plurality of layers. Such layers may be significantly more tightly bonded together than the bonding (if any) of the contact areas. Both tight and relatively weak bonding can be accomplished by joining layers by mechanical pressure, joining layers with heat, joining with heat and pressure, joining layers with adhesives, spread coating, extrusion coating, ultrasonic bonding, static bonding, cohesive bonding, and combinations thereof. Adjacent sub-layers of an individual film may be coextruded. Co-extrusion results in tight bonding so that the bond strength is greater than the tear resistance of the resulting laminate (i.e., rather than allowing adjacent layers to be peeled apart through breakage of the lamination bonds, the film will tear).

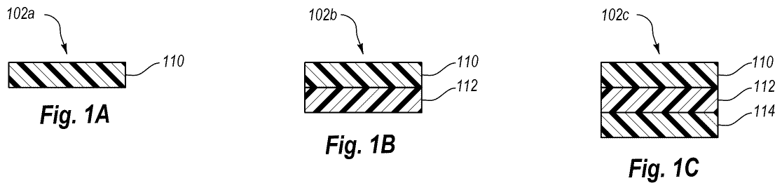

A thermoplastic film can include one, two, three, or more layers of thermoplastic material. FIGS. 1A-1C are partial cross-sectional views of films that can be included in a thermoplastic bag of one or more implementations. In some implementations, the film may include a single layer film 102a, as shown in FIG. 1A, comprising a single first layer 110. In other embodiments, the film can comprise a two-layer film 102b as shown in FIG. 1B, including a first layer 110 and a second layer 112. The first and second layers 110, 112 can be coextruded. In such implementations, the first and second layers 110, 112 may optionally include different grades of thermoplastic material and/or include different additives, including polymer additives and/or pigments. In yet other implementations, a film may be a tri-layer film 102c, as shown in FIG. 1C, including a first layer 110, a second layer 112, and a third layer 114. In yet other implementations, a film may include more than three layers. The tri-layer film 102c can include an A:B:C configuration in which all three layers vary in one or more of gauge, composition, color, transparency, or other properties. Alternatively, the tri-layer film 102c can comprise an A:A:B structure or A:B:A structure in which two layers have the same composition, color, transparency, or other properties. In an A:A:B structure or A:B:A structure the A layers can comprise the same gauge or differing gauge. For example, in an A:A:B structure or A:B:A structure the film layers can comprise layer ratios of 20:20:60, 40:40:20, 15:70:15, 33:34:33, 20:60:20, 40:20:40, or other ratios. In one or more implementations, the first, second, and third layers 110, 112, 114 are coextruded.

In one example, the film 102a can comprise a 0.5 mil, 0.920 density LLDPE, colored film containing 4.8% pigment that appears a first color. In an alternative embodiment, the film 102a can comprise a 0.5 mil, 0.920 density LLDPE, un-pigmented film that appears clear or substantially clear. In still further embodiments, the film 102a can comprise a 0.5 mil, 0.920 density LLDPE, pigmented film that appears a second color.

In at least one implementation, such as shown in FIG. 1C, a multilayered film 102c can include coextruded layers. For example, the film 102c can include a three-layer B:A:B structure, where the ratio of layers can be 20:60:20. The exterior B layers (i.e., the first layer 110, and the third layer 114) can comprise a mixture of hexene LLDPE of density 0.918 and metallocene LLDPE of density 0.920. The interior A core layer (i.e., the second layer 112) can comprise a mixture of hexene LLDPE of density 0.918, butene LLDPE of density 0.918, and reclaimed resin from trash bags. Additionally, the A core layer (i.e., the second layer 112) can include a pigment. For example, the A core layer can include a colorant in an amount between about 0.1 percent and about 6 percent.

In another example, the film 102c is a coextruded three-layer B:A:B structure where the ratio of layers is 15:70:15. The B:A:B structure can also optionally have a ratio of B:A that is greater than 20:60 or less than 15:70. In one or more implementations, the LLDPE can comprise greater than 50% of the overall thermoplastic material in the film 102c.

In another example, the film 102c is a coextruded three-layer C:A:B structure where the ratio of layers is 20:60:20. The C layer (i.e., the first layer 110) can comprise a LLDPE material with a first colorant (e.g., black). The B layer (i.e., the third layer 114) can comprise a LLDPE material with a second colorant (e.g., white). The LLDPE material can have a MI of 1.0 and density of 0.920 g/cm³. The A core layer (i.e., the second layer 112) can comprise similar materials to any of the core layers described above. The A core layer can comprise a black colorant, a white colorant, or can be clear.

In still further embodiments, a film can comprise any number of coextruded layers. More particularly, in one or more embodiments, a film can comprise any number of coextruded layers so long as the A and B layers do not alternate such that the A layers are on one side and the B layers are on the other side. In still further embodiments, a film can comprise one or more coextruded layers between the A and B layers. For example, the film can comprise clear or transparent layers between the A and B layer(s). In still further embodiments, a film can comprise intermittent layers of different colors in addition to the A and B layer(s).

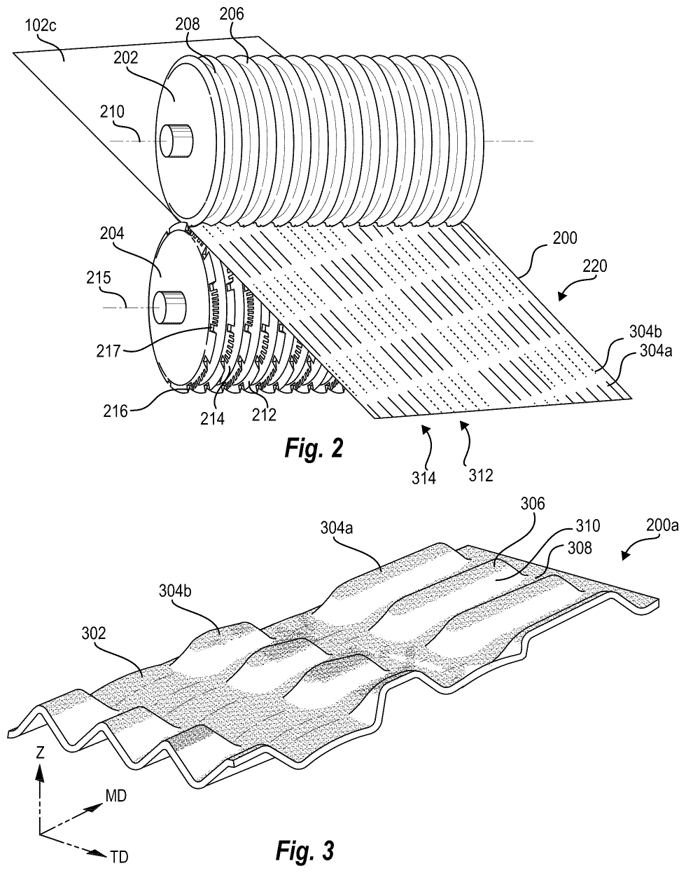

As mentioned above, in one or more implementations, deformations and bonds are simultaneously formed in adjacent films. Specifically, in one or more implementations multiple thermoplastic films are passed together through a pair of intermeshing rollers that both form deformations in the films and bonds between the films. The intermeshing rollers comprise SELF'ing rollers in one or more implementations. FIG. 2 shows a pair of SELF'ing rollers 202, 204 (e.g., a portion of a first SELF'ing roller 202 intermeshed with a second SELF'ing roller 204) for creating strainable networks (e.g., SELF'ing deformations) in a pattern. As shown in FIG. 2, the first SELF'ing roller 202 may include a plurality of ridges 206 and grooves 208 extending generally radially outward in a direction orthogonal to an axis of rotation 210.

Additionally, the second SELF'ing roller 204 may include a plurality of ridges 212 and grooves 214 extending generally radially outward in a direction orthogonal to an axis of rotation 215. As further shown in FIG. 2, in some implementations, the ridges 212 of the second SELF'ing roller 204 may include a plurality of teeth 216 and notches 217 that break up the ridges 212. As shown, the first SELF'ing roller 202 lacks teeth and/or notches that break up the plurality of ridges 206. As a result, the first SELF'ing roller 202 can be similar to a transverse direction (“TD”) intermeshing roller such as the TD intermeshing rollers described in U.S. Pat. No. 9,186,862 to Broering et al., the disclosure of which is incorporated by reference herein in its entirety.

Passing a film (such as the film 102c), through the SELF'ing rollers 202, 204 can produce a thermoplastic film 200 with one or more strainable networks formed by a structural elastic like process in which raised rib-like elements 304a, 304b of the strainable networks form one or more patterns 220. As used herein, the term “strainable network” refers to an interconnected and interrelated group of regions which are able to be extended to some useful degree in a predetermined direction providing the web material with an elastic-like behavior in response to an applied and subsequently released elongation.

In particular, passing a thermoplastic film between the first SELF'ing roller 202 and the second SELF'ing roller 204 can form a plurality of deformations (e.g., raised rib-like elements) in a thermoplastic film that comprise deformation repeat units that are arranged in one or more patterns. In other words, the SELF'ing rollers 202, 204 can form a pattern of deformation repeat units that correspond to (e.g., have the same shape and size) repeat units of ridges 212 of the second SELF'ing intermeshing roller 204.

FIG. 3 shows a portion 200a of the thermoplastic film 200 with the pattern 220 of deformations. As the film passes through the SELF'ing rollers 202, 204, the ridges 206, 212 can press a portion of the film out of plane defined by the film to cause permanent deformation of a portion of the film 200 in the Z-direction. For example, the teeth 216 intermittently stretch a portion of the film 200 in the Z-direction. The portions of the film 200 that pass between the notches 217 of the ridges 212 will remain substantially undeformed in the Z-direction. As a result of the foregoing, the thermoplastic film 200 includes a plurality of isolated deformed, raised, rib-like elements 304a, 304b and at least one un-deformed portion (or web area) 302 (e.g., a relatively flat region). As will be understood by one of ordinary skill in the art, the length and width of the rib-like elements 304a, 304b depend on the length and width of ridges 206, 212 and the speed and the depth of engagement of the SELF'ing rollers 202, 204. The rib-like elements 304a, 304b and the un-deformed web areas 302 form a strainable network and can be grouped together in deformation repeat units that form various patterns (e.g., a checkboard pattern as shown in FIG. 2, diamond patterns, or other patterns as described in greater detail below).

As shown in FIG. 3, the strainable network of the film 200 can include first thicker regions 306, second thicker regions 308, and stretched, thinner transitional regions 310 connecting the first and second thicker regions 306, 308. The thicker regions 306, 308 are thicker regions in that they are thicker than the thinner regions 310. Similarly, the thinner regions 310 are thinner regions in that they are thinner than the thicker regions 306, 308. The first thicker regions 306 and the stretched, thinner regions 310 can form the raised rib-like elements 304a, 304b of the strainable network. In one or more implementations, the first thicker regions 306 are the portions of the film with the greatest displacement in the Z-direction. In one or more implementations, because the film is displaced in the Z-direction by pushing the rib-like elements 304a, 304b in a direction perpendicular to a main surface of the thermoplastic film (thereby stretching the transitional regions 310 upward) a total length and width of the film does not substantially change when the film is subjected to the SELF'ing process of one or more implementations. In other words, the film 102c (film prior to undergoing the SELF'ing process) can have substantially the same width and length as the film 200 (film resulting from the SELF'ing process).

As shown in FIG. 3, in some embodiments, the rib-like elements have a major axis and a minor axis (i.e., the rib-like elements are elongated such that they are longer than they are wide). As shown by FIG. 3, in one or more implementations, the major axes of the rib-like elements are parallel to the machine direction (i.e., the direction in which the film was extruded). In alternative implementations, the major axes of the rib-like elements are parallel to the transverse direction. In still further implementations, the major axes of the rib-like elements are oriented at an angle between 0 and 90 degrees relative to the machine direction. For example, in one or more implementations, the major axes of the rib-like elements are at a 45-degree angle to the machine direction. In one or more implementations, the major axes are linear (i.e., in a straight line). In alternative implementations the major axes are curved or have otherwise non-linear shapes.

The rib-like elements 304a, 304b can undergo a substantially “geometric deformation” prior to a “molecular-level deformation.” As used herein, the term “molecular-level deformation” refers to deformation that occurs on a molecular level and is not discernible to the normal naked eye. That is, even though one may be able to discern the effect of molecular-level deformation (e.g., elongation or tearing of the film), one is not able to discern the deformation that allows or causes the effect to happen. This is in contrast to the term “geometric deformation,” which refers to deformations that are generally discernible to the normal naked eye (e.g., when a SELF'ed film or articles embodying such a film are subjected to an applied load or force). Types of geometric deformation include, but are not limited to bending, unfolding, and rotating.

Thus, upon application of a force, the rib-like elements 304a, 304b can undergo geometric deformation before undergoing molecular-level deformation. For example, a strain applied to the film 200 within the plane of the film 200 in a direction perpendicular to the major axes of the rib-like elements 304a, 304b can pull the rib-like elements 304a, 304b back into plane with the web areas 302 prior to molecular-level deformation of the rib-like elements 304a, 304b. Geometric deformation can result in significantly less resistive force to an applied strain than that exhibited by molecular-level deformation.

As mentioned above, the rib-like elements 304a, 304b and the web areas 302 can be sized and positioned so as to create any pattern of deformation repeat units. In one or more implementations, the deformation repeat units are visually distinct from the web areas 302. As used herein, the term “visually distinct” refers to features of the web material which are readily discernible to the normal naked eye when the web material or objects embodying the web material are subjected to normal use.

As mentioned above, the rib-like elements 304a, 304b can provide the film 200 with increased elasticity. In particular, the rib-like elements 304a, 304b can unfold and bend prior to stretching the web areas 302 or the rib-like elements 304a, 304b themselves. As such, areas of the film with larger rib-like elements 304a, 304b and more rib-like elements 304a, 304b can have greater elasticity and can be expanded to greater lengths before undergoing molecular-level deformation. As such, portions of the thermoplastic film can be tailored to have desired strength and elasticity based on sizing/density of the rib-like elements 304a, 304b.

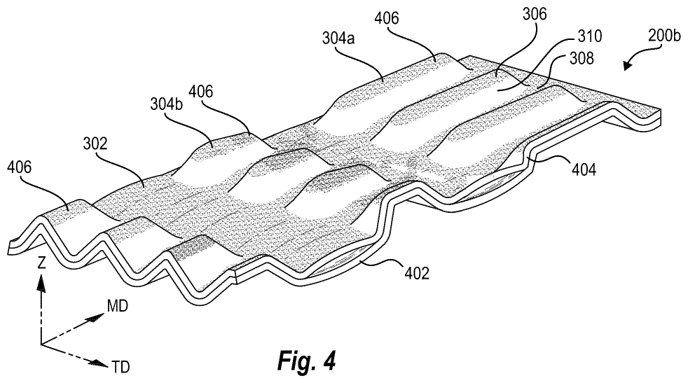

In one or more implementations, films with deformations or raised rib-like elements may comprise two or more distinct portions of one or more thermoplastic films. The distinct portions of the films are non-continuously bonded to one another during the creation of the raised rib-like elements. For example, in one or more implementations two film layers can be passed together through a pair of SELF'ing rollers to produce a multi-layered lightly bonded laminate film 200b, as shown in FIG. 4. The multi-layered lightly bonded laminate film 200b can comprise a first thermoplastic film 402 discontinuously bonded to a second thermoplastic film 404. In one or more implementations, the bonds 406 between the first thermoplastic film 402 and the second thermoplastic film 404 are aligned with the first thicker regions 306 and are formed by the pressure of the SELF'ing rollers displacing the raised rib-like elements 304a, 304b. In particular, the bonds 406 can run along the top of the raised rib-like elements 304a, 304b. In one or more implementations, the bonds 406 are positioned between raised rib-like elements 304a, 304b of the first thermoplastic film 402 and the second thermoplastic film 404. Furthermore, the bonds 406 are above the stretched, thinner transitional regions 310 connecting the first and second thicker regions 306, 308 (in the z-direction).

As mentioned, in one or more implementations, the bonds 406 between the first thermoplastic film 402 and the second thermoplastic film 404 are broken to increase a puncture resistance of the multi-layered lightly bonded laminate film 200b. Specifically, after forming the raised rib-like elements 304a, 304b, a spreader bar can be passed between the 406 between the first thermoplastic film 402 and the second thermoplastic film 404 to break, delaminate, or release the bonds 406 in one more regions. By breaking the bonds 406, the first thermoplastic film 402 and the second thermoplastic film 404 are no longer secured to each other and are free to move or shift relative to each other. Relative movement between the first thermoplastic film 402 and the second thermoplastic film 404 help ensure that any weak points in the first thermoplastic film 402 and the second thermoplastic film 404 are no longer aligned in one or more of the MD or TD directions. As such, breaking the bonds 406 increases puncture resistance by helping ensure that an object being pressed into the multi-layered lightly bonded laminate film 200b will not pass through corresponding weak points in both the first thermoplastic film 402 and the second thermoplastic film 404.

In some implementations, the first and second films 402, 404 may be bonded such that the bonded regions have bond strengths below a strength of the weakest film of the first and second films 402, 404. In other words, the bonded regions may fail (e.g., break apart) before the first or second films 402, 404 fail. As a result, discontinuously bonding the first and second films 402, 404 may also increase or otherwise modify one or more of the tensile strength, tear resistance, impact resistance, or elasticity of the films. Furthermore, the bonded regions between the first and second films 402, 404 may provide additional strength. Such bonded regions may be broken to absorb forces rather than such forces resulting in tearing of the film or causing an adjacent hem seal to fail.

Furthermore, any of the pressure techniques (i.e., bonding techniques) described in U.S. Pat. No. 8,603,609 may be combined with other techniques in order to further increase the strength of the bonded regions while maintaining bond strength below the strength of the weakest layer of the multi-layer laminate film. For example, heat, pressure, ultrasonic bonding, corona treatment, or coating (e.g., printing) with adhesives may be employed. Treatment with a corona discharge can enhance any of the above methods by increasing the tackiness of the film surface so as to provide a stronger lamination bond, but which is still weaker than the tear resistance of the individual layers.

Discontinuously bonding the first and second films 402, 404 together results in un-bonded regions and bonded regions between the first and second films 402, 404. For example, discontinuously bonding the first and second films 402, 404 together may result in un-bonded regions and bonded regions as described in U.S. Pat. No. 9,637,278, the disclosure of which is incorporated by reference herein in its entirety.

In addition to the foregoing, the first and second film 402, 404 can have differing colors. For example, in one or more implementations, the first film 402 is a translucent or transparent film that is lightly pigmented (e.g., light blue, light green), while the second film 404 is opaque or less transparent that the first film 404. In one or more implementations, the second film 404 can comprise a white color. The contrasting color of the first and second film 402, 404 can create a visual distinction between the bonded areas and the non-bonded areas of the films 402, 404, which in turn can make the deformations and pattern easier to see (e.g., more visually distinct).

More particularly, one or more implementations involve forming a multi-film laminate with a metallic appearance or color that is distinct from the color and appearance of the individual layers of the multi-layer film. For example, a pigmented first layer can have a black appearance while the second layer has a clear or transparent appearance. When bonded together via SELF'ing to form a multi-layer film in accordance with the principles described herein, the resultant multi-layer film can have a metallic, silvery metallic, or light grey color rather than a black appearance or color as would be expected. Once such a multi-layer film with a unique appearance is formed, one or more implementations involve bringing regions or areas of the two layers into intimate contact with each other to create visually distinct regions that have the color or appearance of the pigmented layer (e.g., the bonded raised rib-like elements described above). For example, a multi-layer film with a black first layer and a transparent second layer can have a silver metallic appearance and black visually distinct regions where the two films are in intimate contact with each other.

In another example, a pigmented first layer can have a black appearance while the second pigmented layer has a white appearance. When combined to form a multi-layer film in accordance with the principles described herein, the resultant multi-layer film can have a light grey color rather than a black or white appearance or color as would be expected. Once such a multi-layer film with a unique appearance is formed, one or more implementations involve bringing regions or areas of the two layers into intimate contact with each other to create visually distinct regions that have the color or appearance of the black pigmented layer or a dark grey appearance. For example, a multi-layer film with a black first layer and a white second layer can have a light grey appearance and black or dark grey visually distinct regions where the two films are in intimate contact with each other. In one or more embodiments, the amount of pigment in the first layer can determine whether the portions in intimate contact have a black color or a dark grey color.

In one or more embodiments, the first layer comprises a light colorant while the second layer comprises a dark colorant. As used herein a light colorant is a color with a brightness closer to the brightness of white than the brightness of black. As used herein a dark colorant is a color with a brightness closer to the brightness of black than the brightness of white. In one or more embodiments, the first layer has a concentration of light colorant between about 1% by mass and about 15% by mass. More particularly, in one or more embodiments, the first layer has a concentration of light colorant between about 2% by mass and about 12% by mass. In still further embodiments, the first layer has a concentration of light colorant between about 5% by mass and about 10% by mass.

In one or more embodiments, the second layer has a concentration of dark colorant between about 1% by mass and about 15% by mass. More particularly, in one or more embodiments, the second layer has a concentration of dark colorant between about 2% by mass and about 12% by mass. In still further embodiments, the second layer has a concentration of dark colorant between about 5% by mass and about 10% by mass. One will appreciate in light of the disclosure herein that black and white are used as exemplary colors for ease in explanation. In alternative embodiments, the films can comprise other color combinations such as white over blue, yellow over blue, red over blue, etc.

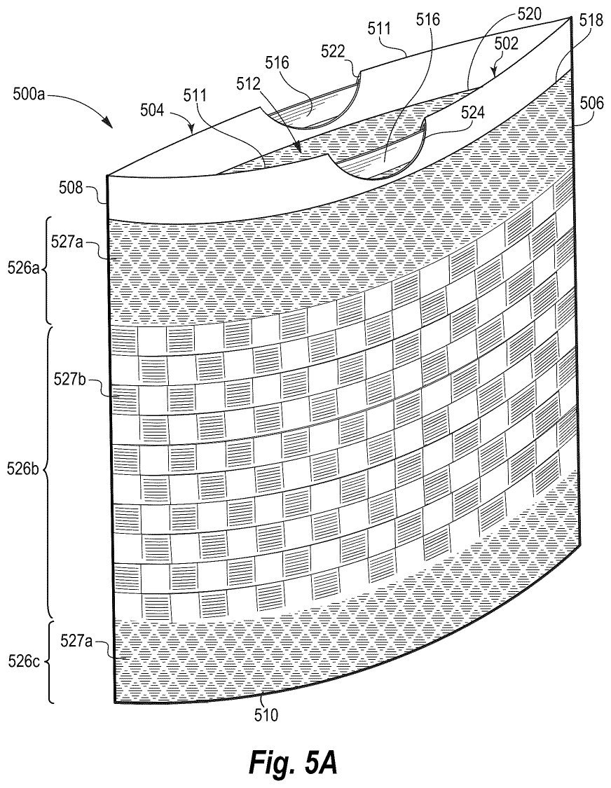

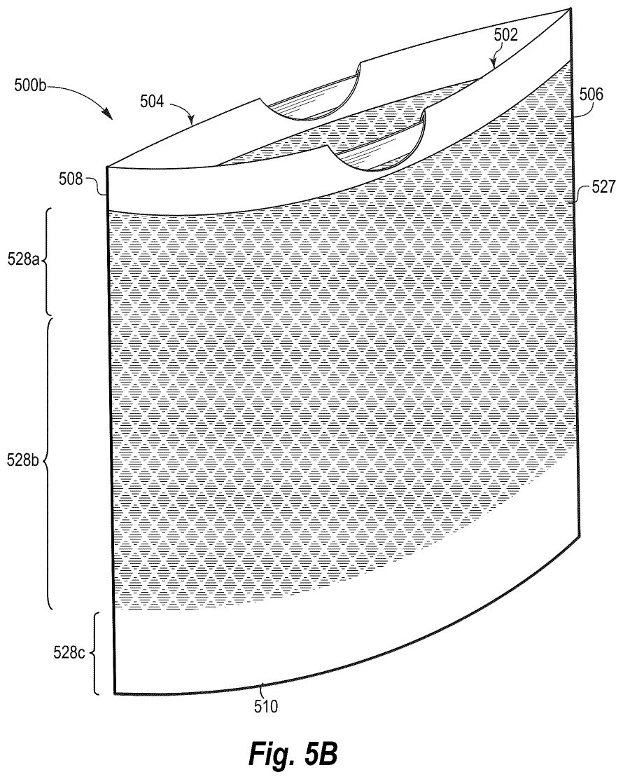

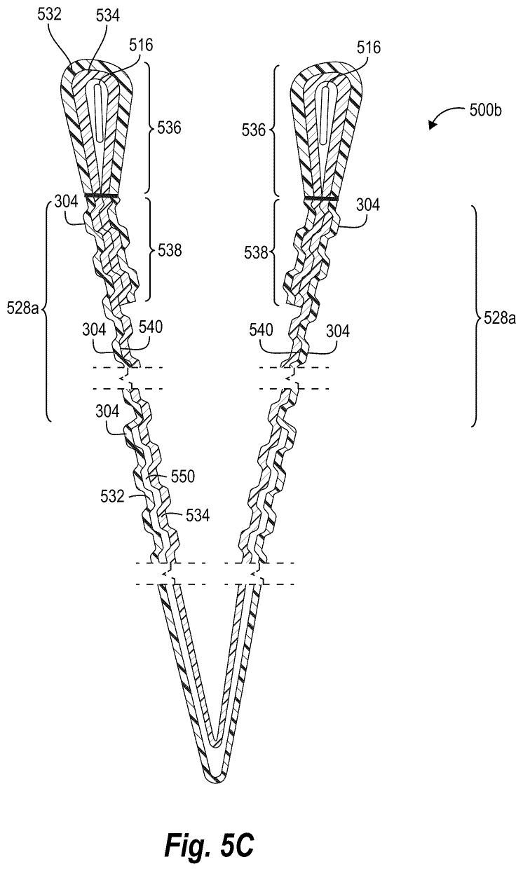

As mentioned above, one or more implementations involve tailoring regions of a thermoplastic bag to include regions more resistant to tearing and punctures by selectively delaminating deformation bonds. FIG. 5A is a perspective view of a thermoplastic bag 500a according to one or more embodiments. The thermoplastic bag 500a includes a first sidewall 502 and a second sidewall 504. Each of the first and second sidewalls 502, 504 includes a first side edge 506, a second opposite side edge 508, and a bottom edge 510 extending between the first and second side edges 506, 508. Each of the first and second sidewalls 502, 504 also includes a top edge 511 extending between the first and second side edges 506, 508 opposite the bottom edge 510. In some implementations, the first sidewall 502 and the second sidewall 504 are joined together along the first side edges 506, the second opposite side edges 508, and the bottom edges 510. The first and second sidewalls 502, 504 may be joined along the first and second side edges 506, 508 and bottom edges 510 by any suitable process such as, for example, a heated pressure seal. In alternative implementations, the first and second sidewalls 502, 504 may not be joined along the side edges. Rather, the first and second sidewalls 502, 504 may be a single uniform piece. In other words, the first and second sidewalls 502, 504 may form a sleeve or a balloon structure.

In some implementations, the bottom edge 510 or one or more of the side edges 506, 508 can comprise a fold. In other words, the first and second sidewalls 502, 504 may comprise a single unitary piece of material. The top edges 511 of the first and second sidewalls 502, 504 may define an opening 512 to an interior of the thermoplastic bag 500a. In other words, the opening 512 may be oriented opposite the bottom edge 510 of the thermoplastic bag 500a. Furthermore, when placed in a receptacle (e.g., a trash can), the top edges 511 of the first and second sidewalls 502, 504 may be folded over the rim of the receptacle.

In some implementations, the thermoplastic bag 500a may optionally include a closure mechanism located adjacent to the top edges 511 for sealing the top of the thermoplastic bag 500a to form an at least substantially enclosed or a fully enclosed container or vessel. As shown in FIG. 5A, in some implementations, the closure mechanism comprises a draw tape 516, a first hem seal 518, and a second hem seal 520. In particular, the first top edge 511 of the first sidewall 502 may be folded over into the interior volume of the thermoplastic bag 500a and may be attached or secured to an interior surface of the first sidewall 502 by the first hem seal 518. Similarly, the second top edge 511 of the second sidewall 504 may be folded over into the interior volume and may be attached to an interior surface of the second sidewall 504 by the second hem seal 520.

Furthermore, in some implementations, each of the first and second hem seals 518, 520 comprises a continuous contact area, such that the layers of the thermoplastic bag 500a secured together by the first and second hem seals 518, 520 are in intimate contact with one another to form the first and second hem seals 518, 520. In some implementations, for example, the first top edge 511 of the first sidewall 502 is folded over into the interior volume and attached or secured to the interior surface of the first sidewall 502 by simultaneous application of heat on an outside face of the first sidewall 502 and pressure between the outside face and an inside face (e.g., within the interior volume) of the first sidewall 502. Similarly, the second top edge 511 of the second sidewall 504 is folded over into the interior volume and attached or secured to the interior surface of the second sidewall 504 by simultaneous application of heat on an outside face of the second sidewall 504 and pressure between the outside face and an inside face (e.g., within the interior volume) of the second sidewall 504. Alternatively, the hem seals are formed by pressure without the application of heat or by ultrasonics.

As illustrated, the draw tape 516 extends through hem channels created by the first and second hem seals 518, 520 along the first and second top edges 511. The hem channel created by the first hem seal 518 includes a first aperture 524 (e.g., notch) extending through the hem channel and exposing a portion of the draw tape 516. Similarly, the hem channel created by the second hem seal 520 includes a second aperture 522 extending through the hem channel and exposing another portion of the draw tape 516. During use, pulling the draw tape 516 through the first and second apertures 522, 524 will cause the top edges 511 to constrict. As a result, pulling the draw tape 516 through the first and second apertures 522, 524 will cause the opening 512 of the thermoplastic bag 500a to at least partially close or reduce in size. The draw tape closure mechanism may be used with any of the implementations of a thermoplastic bag described herein.

Although the thermoplastic bag 500a is described herein as including a draw tape closure mechanism, one of ordinary skill in the art will readily recognize that other closure mechanisms may be implemented into the thermoplastic bag 500a. For example, in some implementations, the closure mechanism may include one or more of flaps, adhesive tapes, a tuck and fold closure, an interlocking closure, a slider closure, a zipper closure, or any other closure structures known to those skilled in the art for closing a bag.

In some implementations, each of the sidewalls 502, 504 of the thermoplastic bag 500a comprise a multi-film thermoplastic structures, such as that shown and described in connection with FIG. 4. Thus, each sidewall 502, 504 can include at least an inner layer and an outer layer. Indeed, the thermoplastic bag 500a can have a bag-in-bag structure. In other words, the thermoplastic bag 500a can include a first thermoplastic bag and a second thermoplastic bag positioned therein. More particularly, the first thermoplastic bag can comprise first and second opposing sidewalls joined together along a first side edge, an opposite second side edge, and a closed first bottom edge. The second thermoplastic bag can be positioned within the first thermoplastic bag. The second thermoplastic bag can comprise third and fourth opposing sidewalls joined together along a third side edge, an opposite fourth side edge, and a closed second bottom edge. In one or more implementations, the first thermoplastic bag (e.g., the outer film) may be pigmented with a first color, and the second thermoplastic bag (e.g., the inner film) may be pigmented with a second color.

As shown in FIG. 5A, the thermoplastic bag 500a includes a first region (e.g., a grab zone) 526a, a second region 526b, and a third region 526c. The first region 526a covers a portion of the thermoplastic bag 500a extending from closure mechanism (specifically the first hem seal 518 and the second hem seal 520 or the draw tape 516) toward the bottom edge 510 of the thermoplastic bag 500a. In other words, the first region 526a is adjacent to the closure mechanism. The second region 526b covers a portion of the thermoplastic bag 500a extending from an end of the first region 526a toward the bottom edge 510 of the thermoplastic bag 500a. The third region 526c covers a portion of the thermoplastic bag 500a extending from an end of the second region 526b to the bottom edge 510 of the thermoplastic bag 500a.

As shown in FIG. 5A, in one or more implementations, the first region 526a is smaller than the second region 526b and larger than the third region 526c. In other words, the first region 526a has a smaller surface area than the second region 526b but a larger surface area than the third region 526c. In alternative implementations, the second region 526b is smaller in total surface area than the first region 526a. Similarly, in one or more implementations the third region 526c is larger in total surface area than the first region 526a and the second regions 526b

Additionally, the first region 526a includes a first pattern 527a of deformations including raised rib-like elements in a strainable network (e.g., a SELF'ed pattern). The first pattern 527a of raised rib-like elements shown in FIG. 5A includes a medium pattern density and exists on the outer and inner surfaces of the first and second sidewalls 502, 504. Moreover, in some implementations, the first pattern 527a of raised rib-like elements is registered to the same location on the second sidewall 504 of the thermoplastic bag 500a.

As shown by FIG. 5A, the first pattern 527a of raised rib-like elements can comprise a repeating pattern of raised rib-like elements in diamond shapes. In particular, the first pattern 527a of deformations can include a first plurality of rib-like elements arranged in a pattern. Portions of the raised rib-like elements of the outer layer can be in direct contact and have the appearance of the inner layer of the thermoplastic bag 500a. The first pattern 527a of raised rib-like elements in the first region 526a (e.g., the grab zone) provide the first region 526a with a unique visual appearance that connotes strength. Additionally, as mentioned above, the raised rib-like elements in the grab zone can provide increased elasticity and strength. As such, the raised rib-like elements can provide the grab zone with both a look and feel of increased strength.

While FIG. 5A illustrates the first pattern 527a of raised rib-like elements in the first region 526a (e.g., the grab zone) comprising repeating diamond-shaped elements, other implementations can comprise differently shaped raised rib-like elements and/or patterns of raised rib-like elements. For example, the patterns of raised rib-like elements can include squares, circles, ovals, stars, hexagons, or other shapes. As such, the use of diamond-shaped patterns of raised rib-like elements is for illustrative purposes and does not limit the implementations of the present invention.

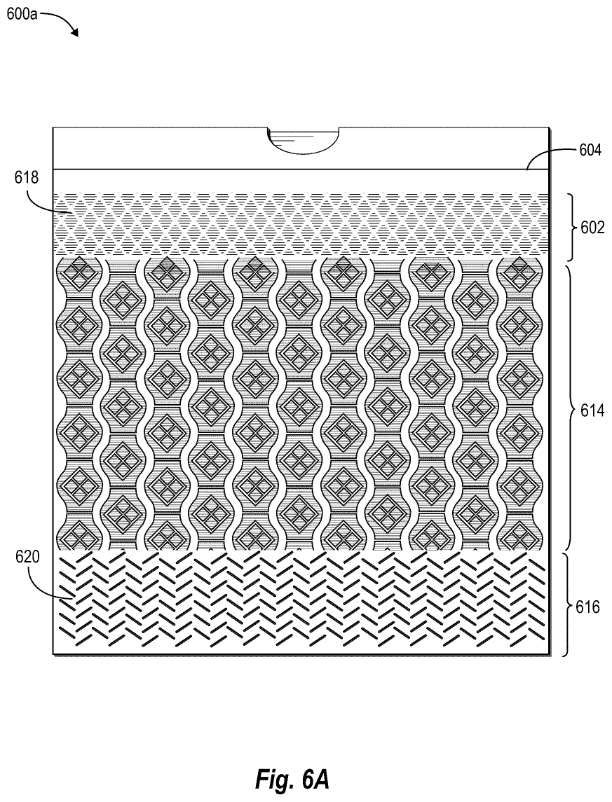

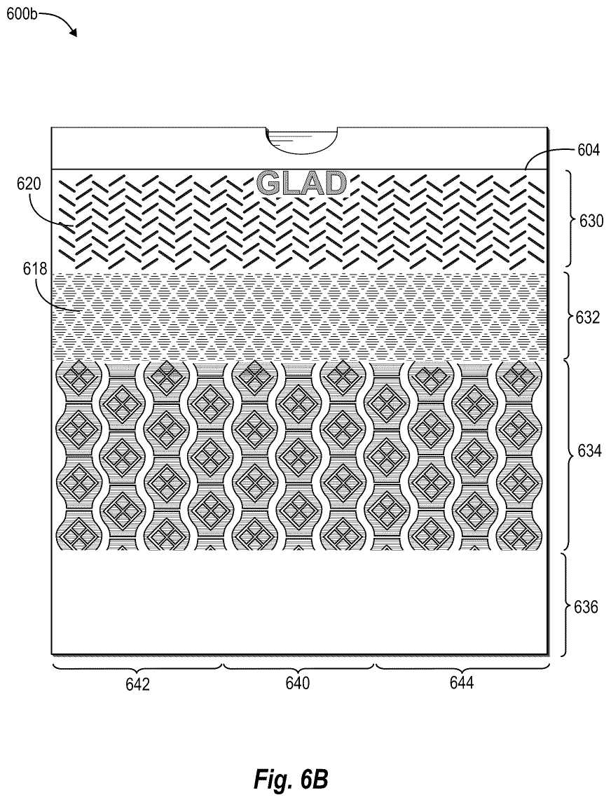

In any event, in one or more implementations, the raised rib-like elements in the grab zone can bond or laminate the hem skirt to the sidewalls 502, 504. Bonding the hem skirt to the sidewalls 502, 504 can help ensure that the hem skirt stays secured to the sidewalls 502, 504, and thereby can help provide an additional layer in the first region 526a. The additional layer can help ensure that a user does not pierce, rip, or puncture the thermoplastic bag 500a in the grab zone when pulling, carrying, or lifting the thermoplastic bag 500a. Additionally, the additional bonds between the respective sidewall 502, 504 and the hem skirt can provide increased strength to the top of the bag. For example, the additional bonds created by SELF'ing the hem skirt to the sidewalls can reinforce the hem seals 518, 520. This increased strength in the first region 526a and at the top of the thermoplastic bag 500a is in addition to the increased elasticity associated with SELF'ing. In alternative implementations, such as FIG. 6A, the hem skirt is not bonded to the side walls. Rather there is a gap between the closure mechanism and the beginning of the SELFing pattern.

In one or more implementations, the second region 526b includes a second pattern 527b of deformations including raised rib-like elements in a strainable network (e.g., a SELF'ed pattern). For example, as shown in FIG. 5A, the second region 526b includes a checkerboard pattern of SELF'ed squares as described in U.S. Pat. No. 11,485,108 entitled “THERMOPLASTIC FILMS AND BAGS WITH COMPLEX STRETCH PATTERNS AND METHODS OF MAKING THE SAME,” hereby incorporated by reference in its entirety.

As shown by FIG. 5A, the second pattern 527b of deformations can comprise a repeating pattern of raised rib-like elements. As with the first pattern 527a, the second pattern 527b of deformations can include a first plurality of rib-like elements arranged in a pattern. Similarly, portions of the raised rib-like elements of the outer layer can be in direct contact and have the appearance of the inner layer of the thermoplastic bag 500a. Both of the patterns 527a and 527b of raised rib-like elements in the first region 526a and the second region 526b can provide pleasing aesthetics, and visual and tactile cues of strength and durability without substantially changing the length and/or width of the films in the first region 526a and the second region 526b.

In some embodiments, such as that shown in FIG. 5A, the thermoplastic bag 500a includes the third region 526c. The third region 526c of the thermoplastic bag 500a shown in FIG. 5A includes a plurality of raised rib-like elements arranged in the SELF'ing pattern 527a described above. The third region 526c is positioned adjacent the bottom edge 510. Furthermore, as shown, the third region 526c is positioned between the second region 526b and the bottom edge 510.

The thermoplastic bag 500a, as shown, includes side seals (e.g., heat seals, ultrasonic seals) along the side edges 506, 508. As shown, the side seals can comprise areas in which all two or more layers of the thermoplastic bag are in intimate contact and sealed or fused together. Sealed or fused seals differ from the bonds between the raised rib-like elements in the regions 526a, 526b in that the sealed or fused seals will not separate prior to failure of the thermoplastic films bonded by the sealed or fused seals.

In one or more implementations, the bonds between the different layers formed when creating the patterns of raised rib-like elements in the first region 526a provides supplementary strength to the hem seals and/or the side seals in the thermoplastic bag 500a. For example, in one or more implementations, the bonds at the raised rib-like elements in the first region 526a increase the strength of the first hem seal 518 on the first sidewall 502, the second hem seal 520 on the second sidewall 504, and side seals by absorbing some of the force that would typically be applied to the first or second hem seals 518, 520 or the side seals. To illustrate, conventional draw tape thermoplastic bags can experience weakness in the hem and side seals due to an incomplete seal or other flaw. Thus, in one or more implementations, the bonds of the raised rib-like elements in the first region 526a increase the strength of the potentially weak hem or side seals near the top of the thermoplastic bag 500a by providing additional force holding the layers together in the grab zone.

In some embodiments, a multi-layer film includes delaminated layers in at least a portion of the film. For example, a multi-layer film can include deformations in both layers of a two-layer film or in all layers of a three-layer film, with some of the deformations delaminated between layers. For instance, when initially formed, the deformations in one layer align with and bond to corresponding deformations in an adjacent layer. Thus, the layers are, at least initially, laminated. However, in some implementations, at least a portion of the multi-layer film is delaminated, such that adjacent layers are no longer bonded within a region of the film. For example, the layers of the multi-layer film are separated such that the deformations within the region of separation do not necessarily line up, and such that the bonds between the layers are broken.

Thus, in some implementations, a thermoplastic bag includes a multi-layer film with delaminated layers that previously had been laminated. To illustrate, in some embodiments, the thermoplastic bag 500a shown in FIG. 5A includes a delaminated portion within the second region 526b and/or the third region 526c. By contrast, in some implementations, the first region 526a of the thermoplastic bag 500a remains laminated.

Stated differently, in some implementations, the thermoplastic bag 500a includes an area within the first sidewall 502 (e.g., the first region 526a) that has a first plurality of deformations (e.g., the deformations in the first pattern 527a). Additionally, the first region 526a includes a first plurality of bonds joining a first thermoplastic film layer to a second thermoplastic film layer of the first sidewall 502. The plurality of bonds are aligned with the plurality of deformations (as shown and described above in relation to FIG. 4). The first region 526a comprising a first puncture resistance.

By contrast, a second region 526b of the first sidewall 502 includes a second plurality of deformations in both the first and second thermoplastic film layers of the first sidewall 502. The second region 526b is devoid of bonds between the layers of the first sidewall 502. Specifically, the bonds formed when creating the SELF'ing pattern 527b have been broken such that the layers of the first sidewall 502 are delaminated in the second region 526b. The second region 526b has a second puncture resistance that is greater than the first puncture resistance of the first region 526a. Specifically, the lack of bonds securing the raised rib-like elements of the SELF'ing pattern 527b allow the layers of the first sidewall 502 so move relative to each other and/or create an air gap between the layers of the first sidewall 502. The relative movement of the layers of the first sidewall 502 and/or the gap between the layers of the first sidewall 502 in the second region 526b help ensure that any weak points or stress concentrations in the SELF'ing pattern 527b in the layers of the second sidewall 502 are not aligned, which increases the puncture resistance of the second area 526b as described above.

As mentioned above, the second region 526b can have a greater puncture resistance than the first region 526a due to the bonds in the second region 526b being broken while the bonds in the first region 526a are intact. As the second region 526b may absorb more forces than the other regions of the thermoplastic bag 500a the trash is placed in the thermoplastic bag 500a (due to trash pushing out against the sidewalls in the second region 526b as trash is pushed into the thermoplastic bag 500a, the increased puncture resistance in the second region 526b due to the delaminated bonds can help prevent punctures and tears. In one or more implementations, the second puncture resistance of the second region 526a is at least 5, 10, 15, 20, 25, 30, 35, 40, 45 or 50 percent greater than the first puncture resistance of the first region 526a.

In some implementations, the delaminated portions(s) (areas lacking bonds created by SELF'ing) of the thermoplastic bag 500a cover an area (e.g., on the first sidewall 502) that is less than half of a total area of the first sidewall 502. Alternatively, in some implementations, the delaminated portions(s) of the thermoplastic bag 500a cover an area (e.g., on the first sidewall 502) that is more than half of a total area of the first sidewall 502.

In some embodiments, the delaminated portion(s) of the thermoplastic bag 500a extend to the bottom edge 510 of the thermoplastic bag 500a. For example, the third region 526c is delaminated (e.g., alternatively to or in addition to the second region 526b being delaminated). In such implementations, the third region 526c of the first sidewall 502 includes a third plurality of deformations in both the first and second thermoplastic film layers of the first sidewall 502. The third region 526c is devoid of bonds created by SELF'ing between the layers of the first sidewall 502. Specifically, the bonds formed when creating the SELF'ing pattern 527a in the third region 526c have been broken such that the layers of the first sidewall 502 are delaminated in the third region 526c. The third region 526c has a third puncture resistance that is greater than the first puncture resistance of the first region 526a. Specifically, the lack of bonds securing the raised rib-like elements of the SELF'ing pattern 527a in the third region 526c allow the layers of the first sidewall 502 so move relative to each other and/or create an air gap between the layers of the first sidewall 502 in the third region 526c. The relative movement of the layers of the first sidewall 502 and/or the gap between the layers of the first sidewall 502 in the third region 526c help ensure that any weak points or stress concentrations in the SELF'ing pattern 527a in the layers of the second sidewall 502 are not aligned, which increases the puncture resistance of the third area 526c as described above. Thus, despite the first region 526a and the third region 526c having the same SELF'ing pattern 527a, the third region 526c comprises a greater puncture resistance compared to the third region 526c due to a lack of bonds between the raised rib-like elements of the SELF'ing pattern 527a in the third region 526c.

One will appreciate that despite the delamination of the bonds in the second region 526b, each of the films in the second region 526b still include a strainable network. Thus, the second region 526b can have both increased elasticity (due to SELF'ing) and increased puncture resistance (due to delamination of the bonds formed during SELF'ing). The combination of increased elasticity (due to SELF'ing) and increased puncture resistance can synergistically strength the second region 526b.

While FIG. 5A illustrates a thermoplastic bag 500a having a first SELF'ing pattern 527a with bonds intact and a second SELF'ing pattern 527b with delaminated bonds, other implementations include a single region in which a first sub portion of the region has intact bonds and a second sub portion of the region as delaminated or broken bonds. In such implementations, a single SELF'ing pattern has different puncture resistance in the first sub portion versus the second sub portion.

For example, ‘illustrates a perspective view of a thermoplastic bag 500b in accordance with one or more embodiments. The thermoplastic bag 500b is similar to the thermoplastic bag 500a in certain respects, and a person of skill in the art having the benefit of this disclosure will recognize that portions of the description above of the thermoplastic bag 500a are also applicable to the thermoplastic bag 500b. Thus, for conciseness of disclosure, some of the description of the thermoplastic bag 500a above will not be repeated for the description of the thermoplastic bag 500b, but nevertheless may still be applicable. This pattern of disclosure also applies to the additional thermoplastic bags described below in connection with other figures.

As shown in FIG. 5B, the thermoplastic bag 500b includes a first sidewall 502, a second sidewall 504, a first side edge 506, a second opposite side edge 508, and a bottom edge 510. Additionally, the thermoplastic bag 500b has a pattern 527 of raised rib-like elements in region made up of a first subregion 528a (e.g., a grab zone) and a second subregion 528b. Moreover, the thermoplastic bag 500b has a third region 528c with a flat portion of the first and second sidewalls 502, 504. While the pattern 527 shown in FIG. 5B comprises repeating diamond-shaped elements, other implementations can comprise differently shaped raised rib-like elements and/or patterns of raised rib-like elements, as noted above.

In some implementations, a portion of the thermoplastic bag 500b includes delaminated layers. For example, in some embodiments, the first subregion 528a includes delaminated layers (i.e., the SELF'ing bonds between the separate films in the first subregion 528a are broken), while the second subregion 528b includes layers that remain lightly laminated (i.e., the SELF'ing bonds between the separate films in the second subregion 528ba are intact). For instance, the pattern 527 of raised rib-like elements in the thermoplastic bag 500b has deformations that align with bonds between the layers of the first sidewall 502 in the second subregion 528b. By contrast, the bonds in the first subregion 528a have been broken (e.g., via a delamination process). In other words, a subregion adjacent a hem seal of the thermoplastic bag 500b includes delaminated layers of the thermoplastic bag 500b. Alternatively, in some implementations, the first subregion 528a (i.e., adjacent the hem seal) remains lightly laminated, while the second subregion 528b is delaminated.

In some alternative embodiments, a delaminated subregion of the thermoplastic bag is adjacent the bottom edge 510. For example, in some embodiments, the pattern 527 of raised rib-like elements extends to the bottom edge 510, and a portion of the thermoplastic bag (e.g., the third region 528c) has delaminated layers with broken bonds, while another portion of the thermoplastic bag (e.g., the second subregion 528b) remains lightly laminated. In some embodiments, multiple unconnected portions of the thermoplastic bag are delaminated. For example, the first subregion 528a and the third region 528c are delaminated (e.g., after first being lightly laminated from a SELF'ing operation) while the second subregion 528b remains lightly laminated.

As mentioned, in some embodiments, the portions of the multi-layer thermoplastic bag with delaminated layers have enhanced dart impact resistance over the portions with lightly laminated layers. Tests were performed on samples of multi-layer thermoplastic film. In a first test on five lightly laminated films, each having two layers of 50% super hexene LLDPE having the diamond pattern of pattern 527, a dart impact strength was measured at an average of 168.5 grams. The five films each were then delaminated (the two layers in each film were separated) and a dart impact strength was measured at an average of 194.5 grams, an increase of 26 grams over the lightly laminated specimens. In other words, the films with delaminated bonds had an increase in puncture resistance over 15% compared to the same film albeit with the bonds intact. Thus, delaminating the films increased their dart impact strength. In this way, the portion(s) of the first and second sidewalls 502, 504 of the thermoplastic bag 500b that are delaminated can have a higher dart impact resistance than the portion(s) of the first and second sidewalls 502, 504 of the thermoplastic bag 500b that remain laminated.

FIG. 5C illustrates a cross-sectional view of one or more implementations of the thermoplastic bag 500b shown in FIG. 5B. For example, as shown in FIG. 5C, the thermoplastic bag 500b includes an outer first thermoplastic bag 532 and an inner second thermoplastic bag 534 positioned within the first thermoplastic bag 532. The top edges of the first thermoplastic bag 532 and the second thermoplastic bag 534 are folded over the draw tape 516 to form a hem channel 536. In one or more implementations, the draw tape 516 is movable in the hem channel 536 so as to cinch the thermoplastic bag 500b closed when pulled through the first and second apertures 522, 524 (e.g., shown in FIG. 5A above).

As discussed above, the sidewalls of the thermoplastic bag 500b can include at least the first subregion 528a including SELF'ing between the first thermoplastic bag 532 and the second thermoplastic bag 534. For example, as shown in FIG. 5C, the first subregion 528a includes raised rib-like elements 304 between the first thermoplastic bag 532 and the second thermoplastic bag 534 where the first thermoplastic bag 532 and the second thermoplastic bag 534 have been lightly laminated via the SELF'ing processes described above. Specifically, the raised rib-like elements 304 in first sidewall of the first thermoplastic bag 532 and raised rib-like elements in the third sidewall of the second thermoplastic bag 534 are joined or laminated together by bonds 540.

As further shown in FIG. 5C, folding over the top edges of the first and second bags 532, 534 creates a hem skirt 538 extending down an inner surface of the second thermoplastic bag 534. As shown, the hem skirt 538 includes portions of the first and second bags 532, 534 that are the same length, or that extend the same distance from the hem channel toward the bottom of the bag 500b. Although FIG. 5C shows the hem skirt 538 including equal lengths of the first and second bags 532, 534, in other implementations the portions of the first and second bags 532, 534 forming the hem skirt 538 can have different lengths. For example, the top edge of the outer first thermoplastic bag 532 can extend a greater length in the hem skirt 538 than the top edge of the inner second thermoplastic bag 534, or vice versa.

The grab zone or first subregion 528a may have a length (distance the grab zone extends from the hem channel 536 toward the bottom of the bag 500b) of between about 1 inch (2.54 cm) to about 10 inches (25.4 cm), between about 3 inches (7.6 cm) to about 8 inches (20.3 cm), between about 4 inches (10.2 cm) to about 6 inches (15.2 cm), or between about 3 inches (7.6 cm) to about 6 inches (15.2 cm). In some implementations, the grab zone has a length of 5 inches (12.7 cm). In some further implementations, the grab zone has a length of 4 inches (10.2 cm). In some other implementations, the grab zone has a length that is shorter or longer than the examples listed above.

As further shown in FIG. 5C, the raised rib-like elements 304 in the first subregion 528a extend through the hem skirt 538. For example, in at least one implementation, the raised rib-like elements 304 in the first subregion 528a are formed after the top edges of the first and second bags 532, 534 are folded over. Thus, the process that forms the raised rib-like elements 304 (e.g., via the SELF'ing rollers 202, 204 shown in FIG. 2 above) also forms raised rib-like elements 304 between the first and second bags 532, 534 and the hem skirt 538, or raised rib-like elements 304 between the sidewalls of the bag 500b and the hem skirt 538.

FIG. 5C shows the first subregion 528a with the first and second bags 532, 534 lightly laminated, while a remainder (e.g., the second subregion 528b and the third region 528c shown in FIG. 5B) of the thermoplastic bag 500b is delaminated. For example, FIG. 5C shows a gap 550 between the first thermoplastic bag 532 and the second thermoplastic bag 534 at locations of delamination. At these locations, the raised rib-like elements 304 in the first thermoplastic bag 532 do not necessarily align with the corresponding raised rib-like elements 304 in the second thermoplastic bag 534, due to the bonds that initially existed between them being broken during the delamination process.

In one or more implementations, one or more patterns of raised rib-like elements can be positioned in various portions of a thermoplastic bag. FIGS. 6A and 6B illustrate implementations of a thermoplastic bag with various configurations of raised rib-like elements. The regions of raised rib-like elements illustrated in the implementations of the thermoplastic bags shown in FIGS. 6A-6B provide multiple advantages. For example, the regions of raised rib-like elements serve to evenly distribute pull and lift forces across the top the thermoplastic bag. Thus, the regions of raised rib-like elements can reduce puncturing and tearing in association with a grab zone of the thermoplastic bag. Moreover, the regions of raised rib-like elements can provide increased strength and elasticity near the hem seals of the thermoplastic bags illustrated in FIGS. 6A-6B. In some cases, the regions of raised rib-like elements provide increased strength and elasticity to the thermoplastic bag. Moreover, in some cases, additional puncture resistance can be imparted to the thermoplastic bag by delaminating portions of the thermoplastic bag (e.g., by breaking some of the bonds between raised rib-like elements across layers in the sidewalls of the thermoplastic bag).

For example, FIG. 6A shows an implementation of a thermoplastic bag 600a with a first region 602 of raised rib-like elements (positioned after the hem skirt such that the hem skirt is not bonded to the sidewall by bonds) and a second region 614 of an additional type of raised rib-like elements. For example, the first region 602 includes a first pattern 618 of raised rib-like elements. The thermoplastic bag 600a also includes a third region 616 including a pattern 620 of contact areas (e.g., portions of a first thermoplastic film that are in intimate contact with portions of a second thermoplastic film and vice versa without thinning or deformation of either the first or the second thermoplastic film). In the implementation shown, the first region 602 of raised rib-like elements may function as a “grab zone,” while the third region 616 of contact areas may function as reinforcement for the bottom of the thermoplastic bag 600a. As shown, in some embodiments, a zone of flat and undeformed areas separates a hem seal 604 from the first region 602.

The first region 602 and the third region 616 are separated by the second region 614 including a plurality of deformations (e.g., SELF'ing) in a different pattern than those in the first region 602. As shown, the second region 614 includes a pattern of elements that includes diamonds and wavy lines. Additionally, the pattern of raised rib-like elements can take up any percentage of the second region 614. In particular, the second region 614 includes a SELF'ing pattern of bulbous areas with nested diamonds. Wavy land areas separate the SELF'ing patterns. In some implementations, the wavy land areas may be contact areas in addition to the contact areas in the first region 602. In other implementations, the first region 602, the second region 614, and the third region 616 can be in any order on the multi-film thermoplastic bag 600a.

In some implementations, a portion of the thermoplastic bag 600a is delaminated after the pluralities of deformations are produced. For instance, in some embodiments, the first region 602 is delaminated while the second region 614 is left lightly laminated. Thus, the layers of the thermoplastic bag 600a are delaminated (e.g., with bonds broken) in the first region 602. In this way, a dart impact resistance of the thermoplastic bag 600a can be increased in the first region 602.

FIG. 6B shows a thermoplastic bag 600b with a first region 630 having a pattern 620 of contact areas, a second region 632 with a pattern 618 of raised rib-like elements, a third region 634 with another pattern of raised rib-like elements, and a fourth region 636 having a flat and undeformed area. In one or more implementations, the pattern 618 of raised rib-like elements may serve to increase the tactile cues of strength and durability, while the pattern 620 of contact areas may serve to increase the visual cues of strength and durability.

In some implementations, the multiple areas of raised rib-like elements or contact areas can be formed into patterns including alpha-numeric characters. For example, as further shown in FIG. 6B, the first region 630 includes contact areas formed into words (e.g., “GLAD”). In other implementations, the areas of raised rib-like elements can be formed into words including brand names, claims, instructions, etc.

Moreover, in some implementations, one or more portions of the thermoplastic bag 600b can be delaminated. For instance, side portions of the thermoplastic bag 600b can be delaminated. To illustrate, a first side portion 642 and a second side portion 644 of the thermoplastic bag 600b can be delaminated, while a middle portion 640 remains laminated. For example, side portions (e.g., within the regions of the first side portion 642 and the second side portion 644) of the second region 632 and the third region 634 can be delaminated. In these portions, the raised rib-like elements can undergo a delamination process that breaks bonds between layers of the thermoplastic bag 600b.

Although FIGS. 5A-6B show regions of raised rib-like elements in various configurations, additional configurations of raised rib-like elements are possible. For example, a thermoplastic bag can include a single continuous region of raised rib-like elements (e.g., extending from the top of the thermoplastic bag to the bottom of the thermoplastic bag). In another implementation, a thermoplastic bag can include multiple strips of raised rib-like elements spaced by flat and undeformed regions. In other implementations, a thermoplastic bag can include regions and/or grab zones of raised rib-like elements in any configuration.

Furthermore, additional configurations of delaminated regions are possible. For example, a thermoplastic bag can have raised rib-like elements that are delaminated adjacent a hem seal, side seals, and a bottom edge, while additional raised rib-like elements remain laminated in a central portion of the thermoplastic bag.

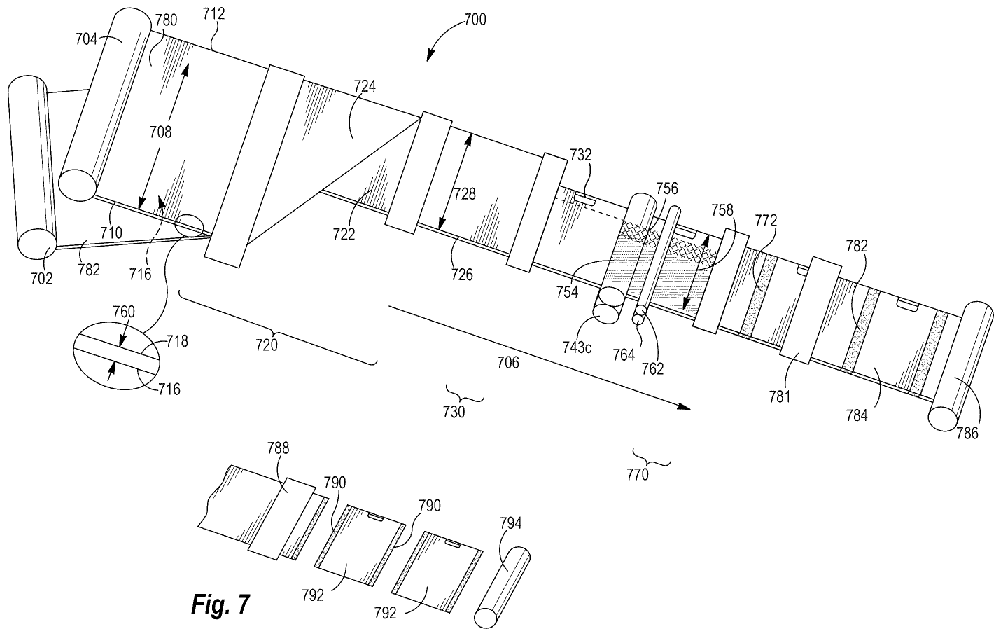

To produce a bag with raised rib-like elements and portions of the bag having delaminated layers as described, continuous webs of thermoplastic material may be processed through a high-speed manufacturing environment such as those illustrated in FIG. 7. In the illustrated process 700, production may begin by unwinding a first continuous web or film 780 of thermoplastic sheet material from a roll 704 and advancing the web along a machine direction 706. The unwound web 780 may have a width 708 that may be perpendicular to the machine direction 706, as measured between a first edge 710 and an opposite second edge 712. The unwound web 780 may have an initial average thickness 760 measured between a first surface 716 and a second surface 718. In other manufacturing environments, the web 780 may be provided in other forms or even extruded directly from a thermoplastic forming process.

In some implementations, the illustrated process 700 involves unwinding a second continuous web or film 782 of thermoplastic sheet material from a roll 702 and advancing the web along a machine direction 706. The second film 782 can comprise a thermoplastic material, a width, and/or a thickness that is similar or the same as the first film 780. Alternatively, in one or more implementations, one or more of the thermoplastic material, width, and/or thickness of the second film 782 can differ from that of the first film 780. To provide the first and second sidewalls of the finished bag, the films 780, 782 may be folded into a first half 722 and an opposing second half 724 about the machine direction 706 by a folding operation 720. When so folded, the first edge 710 may be moved adjacent to the second edge 712 of the web. Accordingly, the width of the films 780, 782 proceeding in the machine direction 706 after the folding operation 720 may be a width 728 that may be half the initial width 708. As may be appreciated, the portion mid-width of the unwound films 780, 782 may become the outer edge of the folded films 780, 782. In any event, a hem channel may be formed by folding adjacent first and second edges 710, 712 over (e.g., at a top edge) and a draw tape 732 may be inserted into the hem channel during a hem channel and draw tape operation 730. In some implementations, as shown in FIG. 7, the hem channel and draw tape operation 730 may fold over a length of the first and second edges 710, 712 such that a hem skirt is formed (e.g., indicated by the dashed line following the operation 730) down an inner surface of the multi-film thermoplastic bag.

To form one or more regions of raised rib-like elements in a multi-film thermoplastic bag, the processing equipment may include at least one set of intermeshing rollers 743a, 743b, and/or 743c (e.g., SELF'ing rollers) that impart one or more patterns of raised rib-like elements in one or more portions, zones, areas, or sections of the resulting multi-film thermoplastic bag and create bonds along the raised rib-like elements. For example, the set of intermeshing rollers 743a form a first pattern 750 through one or more layers of the multi-film thermoplastic bag. In some cases, the set of intermeshing rollers 743a form the pattern 750 through a hem skirt extending down an inner surface of the multi-film thermoplastic bag. Referring to FIG. 7, the folded web 780 may also be advanced along the machine direction 706 between intermeshing rollers 743b (e.g., SELF'ing rollers), which impart a second pattern 752 of raised rib-like elements that bond the hem skirt to the sidewalls.

To avert imparting a pattern (e.g., of raised rib-like elements or otherwise) onto the portion of the web that includes the draw tape 732 or in some implementations, the hem skirt as well, the corresponding ends of the rollers 743a, 743b may be smooth and without ridges, grooves, punch elements, or die elements. Thus, the adjacent edges 710, 712 and the corresponding portion of the web proximate those edges that pass between the smooth ends of the rollers 743a, 743b may not be imparted with any pattern. In alternative implementations, the intermeshing rollers (if present) and the contact rollers are positioned prior to the draw tape insertion process.

The processing equipment may include pinch rollers 762, 764 to accommodate the width 758 of the web 780. Moreover, in some embodiments, the pinch rollers 762, 764 may be configured to delaminate one or more portions of the multi-film thermoplastic bags. For example, in some implementations, the pinch rollers 762, 764 have a tangential velocity slightly greater than a velocity of the multi-film thermoplastic bags along the machine direction 706. In some implementations, the multi-film thermoplastic bags pass over a nip having the width of a desired region for delamination. Additionally, in at least one implementation, the processing equipment spools the bag 784 and other bags produced by the processing equipment into a roll 786 for further processing, or for provision to the end user. In alternative implementations, a spreader bar is passed between films laminated together to selectively break bonds formed by passing the films through the intermeshing rollers in selected regions.

To produce the finished bag, the processing equipment may further process the folded web with at least one region of contact areas. For example, to form the parallel side edges of the finished multi-film thermoplastic bag, the web may proceed through a sealing operation 770 in which heat seals 772 may be formed between the folded edge 726 and the adjacent edges 710, 712. The heat seals may fuse together the adjacent halves 722, 724 of the folded web. The heat seals 772 may be spaced apart along the folded web and in conjunction with the folded outer edge 726 may define individual bags. The heat seals may be made with a heating device, such as, a heated knife. A perforating operation 781 may perforate the heat seals 772 with a perforating device, such as, a perforating knife so that individual bags 784 may be separated from the web. In one or more implementations, the webs may be folded one or more times before the folded webs may be directed through the perforating operation. The web 780 embodying the bags 784 may be wound into a roll 786 for packaging and distribution. For example, the roll 786 may be placed in a box or a bag for sale to a customer.

In one or more implementations of the process, a cutting operation 788 may replace the perforating operation 781. For example, the web may be directed through the cutting operation 788, which cuts the web at locations 790 into individual bags 792 prior to winding onto a roll 794 for packaging and distribution. For example, the roll 794 may be placed in a box or bag for sale to a customer. The bags may be interleaved prior to winding into the roll 794. In one or more implementations, the web may be folded one or more times before the folded web is cut into individual bags 792. In one or more implementations, the bags 792 may be positioned in a box or bag, and not onto the roll 794.

The use in the foregoing description and in the appended claims of the terms “first,” “second,” “third,” etc., is not necessarily to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget, and not necessarily to connote that the second widget has two sides.

In the foregoing description, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with fewer or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A thermoplastic bag comprising:
an outer first thermoplastic bag comprising first and second opposing sidewalls joined together along a first side edge, an opposite second side edge, an open first top edge, and a closed first bottom edge;
an inner second thermoplastic bag positioned within the outer first thermoplastic bag, the inner second thermoplastic bag comprising third and fourth opposing sidewalls joined together along a third side edge, an opposite fourth side edge, an open second top edge, and a closed second bottom edge;
a region in the first sidewall and the third sidewall comprising a plurality of deformations;
a plurality of bonds joining the first sidewall to the third sidewall, the plurality of bonds aligned with the plurality of deformations; and
a subregion within the region, wherein bonds of the plurality of bonds between the first sidewall and the third sidewall in the subregion are broken, wherein the subregion has a greater puncture resistance than portions of the region comprising intact bonds.

2. The thermoplastic bag of claim 1, wherein a puncture resistance of the subregion is at least 10 percent greater than a puncture resistance of the portions of the region comprising intact bonds.

3. The thermoplastic bag of claim 2, wherein a puncture resistance of the subregion is at least 25 percent greater than a puncture resistance of the portions of the region comprising intact bonds.

4. The thermoplastic bag of claim 1, wherein the subregion is adjacent the closed first bottom edge and the closed second bottom edge.

5. The thermoplastic bag of claim 1, wherein the subregion is adjacent a closure mechanism of the thermoplastic bag.

6. The thermoplastic bag of claim 1, wherein the subregion is adjacent the first side edge and the third side edge.

7. The thermoplastic bag of claim 6, further comprising a second subregion, wherein bonds of the plurality of bonds between the first sidewall and the third sidewall in the second subregion are broken, wherein the second subregion has a greater puncture resistance than the portions of the region comprising intact bonds.

8. The thermoplastic bag of claim 7, wherein the second subregion is adjacent the second side edge and the fourth side edge.

9. The thermoplastic bag of claim 1, wherein the plurality of deformations are arranged in a diamond pattern.

10. The thermoplastic bag of claim 1, wherein the plurality of deformations are arranged in a checkerboard pattern.

11. A thermoplastic bag comprising:
a first multi-film sidewall comprising a first thermoplastic film layer and a second thermoplastic film layer;
a second multi-film sidewall comprising a third thermoplastic film layer and a fourth thermoplastic film layer;
a first region in the first multi-film sidewall, the first region comprising: a first plurality of deformations in both the first and second thermoplastic film layers and a first plurality of bonds joining the first thermoplastic film layer to the second thermoplastic film layer, the plurality of bonds being aligned with the plurality of deformations, the first region comprising a first puncture resistance; and
a second region in the first multi-film sidewall, the second region comprising a second plurality of deformations in both the first and second thermoplastic film layers, wherein:
the second region is devoid of bonds joining the first thermoplastic film layer to the second thermoplastic film layer; and
the second region has a second puncture resistance that is greater than the first puncture resistance of the first region.

12. The thermoplastic bag of claim 11, further comprising a closure mechanism along a top of the thermoplastic bag, wherein:
the closure mechanism is configured to selective close the thermoplastic bag; and
the first region is adjacent the closure mechanism.

13. The thermoplastic bag of claim 12, wherein the second region is between the first region and a bottom of the thermoplastic bag.

14. The thermoplastic bag of claim 13, wherein the second region is adjacent the bottom of the thermoplastic bag.

15. The thermoplastic bag of claim 11, wherein:
the second region extends from a first side edge of the thermoplastic bag toward a second side edge of the thermoplastic bag; and
the first region is positioned between the second region and the second side edge of the thermoplastic bag.

16. The thermoplastic bag of claim 11, wherein the first region is larger than the second region.

17. The thermoplastic bag of claim 11, wherein the second region comprises less than half of a total area of the first multi-film sidewall.

18. The thermoplastic bag of claim 11, wherein the first and second plurality of deformations comprise SELF'ing deformations.

19. The thermoplastic bag of claim 11, wherein the second puncture resistance is at least 10 percent greater than the first puncture resistance.

20. The thermoplastic bag of claim 11, wherein the second puncture resistance is at least 20 percent greater than the first puncture resistance.
